(19) United States
(12) Patent Application Publication
(10) Pub. No.: US 2024/0028020 A1
(43) Pub. Date: Jan. 25, 2024

(54) STATE DETERMINATION DEVICE AND STATE DETERMINATION METHOD

(71) Applicant: Fanuc Corporation, Minamitsuru-gun, Yamanashi (JP)

(72) Inventor: Atsushi Horiuchi, Minamitsuru-gun, Yamanashi (JP)

(73) Assignee: Fanuc Corporation, Minamitsuru-gun, Yamanashi (JP)

(21) Appl. No.: 18/024,820

(22) PCT Filed: Sep. 7, 2021
(86) PCT No.: PCT/JP2021/032790

§ 371 Date: Mar. 6, 2023

(30) Foreign Application Priority Data
Sep. 10, 2020 (JP) 2020-152256

(51) Int. Cl. G05B 23/02

(52) U.S. Cl. CPC G05B 23/024; G05B 23/027

(57) ABSTRACT

A state determination device includes: a learning model storage unit that stores a plurality of learning models; a statistical condition storage unit that stores statistical conditions including at least specification of the learning models used to determine the state relating to an industrial machine and a statistical function used to convert estimation results by the specified learning models into numerical values to calculate a statistical amount; a data acquisition unit that acquires data relating to a prescribed physical amount as data showing the state relating to the industrial machine; an estimation unit that estimates the state relating to the industrial machine using the plurality of learning models on a basis of the data; and a numerical value conversion unit that converts an estimation result for each of the plurality of learning models into a numerical value to calculate a statistical amount using the statistical function.

### CROSS REFERENCE TO RELATED APPLICATIONS

This is the U.S. National Phase application of PCT/JP2021/032790, filed Sep. 7, 2021, which claims priority to Japanese Patent Application No. 2020-152256, filed Sep. 10, 2020, the disclosures of these applications being incorporated herein by reference in their entireties for all purposes.

### FIELD OF INVENTION

The present invention relates to a state determination device and a state determination method relating to an industrial machine.

### BACKGROUND OF THE INVENTION

Industrial machines such as injection molding machines are maintained periodically or when abnormality occurs. When maintaining industrial machines, a person in charge of the maintenance determines the presence or absence of the abnormality of the industrial machine using a physical amount showing the operating state of the industrial machine recorded during the operation of the industrial machine and performs a maintenance operation such as the replacement of a component causing the abnormality.

For example, as a maintenance operation for the backflow check valve of an injection cylinder provided in an injection molding machine, there has been known a method in which a screw is periodically pulled out from the injection cylinder and the dimension of the backflow check valve is directly measured. However, this method requires a temporary stop of production to perform a measurement operation, which causes a problem that productivity reduces.

Further, the type of an injection molding machine includes variations different in specifications such as an injection device including an injection cylinder, a mold clamping device, and an apparatus for ejecting a molded article. Therefore, it is necessary to provide state determination devices that determine the presence or absence of the abnormality of an operating state by the number of the variations or set determination standards for the presence or absence of abnormality.

As a conventional technology to solve such problems, there has been known a method in which a wear amount of the backflow check valve of an injection cylinder is indirectly detected to diagnose abnormality without temporarily stopping production such as pulling out a screw from the injection cylinder. According to this method, a rotating torque applied to the screw is detected or a phenomenon in which a resin reversely flows to the back side of the screw is detected to diagnose the abnormality of the operating state of an injection molding machine.

For example, it is described in PTL 1 that the abnormality of the load of a driving unit, a resin pressure, or the like is determined by supervised learning. However, in a machine in which an element constituting the driving unit of an injection molding machine has different specifications, a measurement value obtained from the machine is largely deviated from a numerical value of learning data input during machine learning, which causes a problem that an abnormality determination by the machine learning cannot be properly made.

In view of this, it is described in PTL 2 that, with respect to an abnormal degree estimation value derived by machine learning, a corrected abnormal degree correction value is derived using a correction coefficient associated with the type or equipment of injection molding for an abnormal degree estimation value calculated from one learning model. Further, it is described in PTL 3 that a plurality of learning models corresponding to conditions relating to an injecting operation such as operating conditions and environment conditions are provided in advance. In PTL 3, in calculating an evaluation value for the state of an injecting operation, one learning model is selected from among a plurality of learning models on the basis of the conditions of the injecting operation or processing performance to improve the determination accuracy of machine learning. Moreover, it is described in PTL 4 that a plurality of learning models are provided in advance, learning data classified according to classification conditions and the learning models are associated with each other in advance, and one learning model is selected from among the plurality of learning models.

### PATENT LITERATURE

[PTL 1] Japanese Patent Application Laid-open No. 2017-202632
[PTL 2] Japanese Patent Application Laid-open No. 2020-044718
[PTL 3] Japanese Patent Application Laid-open No. 2019-067138
[PTL 4] Japanese Patent Application Laid-open No. 2020-066178

### SUMMARY OF THE INVENTION

As described above, it is difficult to respond to various production environments or operator's demands in a wide range and comprehensively perform an abnormality determination by machine learning only with one learning model. Meanwhile, a method in which one learning model is selected from among a plurality of learning models has been known, but a comprehensive abnormality determination making use of a plurality of learning models has not been attained.

That is, in order to respond to various production environments or operator's demands, the realization of a comprehensive determination and a general determination making use of “a plurality of state determination results (estimation values)” calculated by a plurality of learning models has been demanded.

In a state determination device according to the present invention, time-series physical amounts (such as a current and a speed) acquired by a controller that controls an industrial machine are used as data showing a state relating to the industrial machine with respect to an abnormal degree estimated by machine learning. Further, the state determination device calculates a plurality of estimation values (abnormal degrees) using a plurality of various learning models. Subsequently, a statistical function associated with the type or equipment of an industrial machine and the learning models is applied to a calculated estimation value for each of the plurality of learning models to calculate a statistical amount used to evaluate the abnormal degree of the industrial machine. Since the calculated statistical amount considers the characteristics of the plurality of learning models, it is possible to comprehensively determine an abnormal degree reflecting the various characteristics with the statistical amount.

Specifically, even if the type of an injection molding machine is different (for example: the size of the machine is small or large) or a facility annexed to the injection molding machine or a resin used as a production material is different, an abnormal degree can be comprehensively determined on the basis of a statistical amount calculated by applying a statistical function associated with a type, an annexed facility, or the like to an estimation value for each of a plurality of learning models. For example, when two learning models for a large machine and a small machine are provided in advance and the abnormal degree of a medium machine different from the types used to generate the learning models is determined, a statistical amount derived by applying weights (for example: 70% for the learning model of the large machine, 30% for the learning model of the small machine) corresponding to the sizes of the machines to two estimation values calculated by the learning models is used as an abnormal degree, whereby it is possible to comprehensively determine an abnormal degree with the two learning models.

Further, an aspect of the present invention provides a state determination device that determines a state relating to an industrial machine, the state determination device including: a learning model storage unit that stores a plurality of learning models having learned correlation between data relating to a prescribed physical amount acquired from the industrial machine and a state relating to the industrial machine; a statistical condition storage unit that stores statistical conditions including at least specification of the plurality of learning models used to determine the state relating to the industrial machine and a statistical function used to convert estimation results by the specified learning models into numerical values to calculate a statistical amount; a data acquisition unit that acquires data relating to a prescribed physical amount as data showing the state relating to the industrial machine; an estimation unit that estimates the state relating to the industrial machine using the plurality of learning models stored in the learning model storage unit on a basis of the data acquired by the data acquisition unit; and a numerical value conversion unit that refers to the statistical condition storage unit to acquire the statistical function and converts an estimation result for each of the plurality of learning models by the estimation unit into a numerical value to calculate a statistical amount using the acquired statistical function.

Further, another aspect of the present invention provides a state determination method for determining a state relating to an industrial machine in which a plurality of learning models having learned correlation between data relating to a prescribed physical amount acquired from the industrial machine and a state relating to the industrial machine are stored in advance, and statistical conditions including at least specification of the plurality of learning models used to determine the state relating to the industrial machine and a statistical function used to convert estimation results by the specified learning models into numerical values to calculate a statistical amount are stored in advance, the state determination method including: a step of acquiring data relating to a prescribed physical amount as data showing the state relating to the industrial machine; a step of estimating the state relating to the industrial machine using the plurality of learning models stored in advance on a basis of data acquired in the acquisition step; and a step of acquiring the statistical function included in the statistical conditions stored in advance and converting an estimation result for each of the plurality of learning models in the estimation step into a numerical value to calculate a statistical amount using the acquired statistical function.

According to an aspect of the present invention, a statistically-processed statistical amount is calculated on the basis of estimation values obtained by a plurality of learning models, whereby it is possible to comprehensively determine a state relating to an industrial machine.

### BRIEF DESCRIPTION OF DRAWINGS

FIG. 1 is a schematic hardware configuration diagram showing a state determination device according to an embodiment.

FIG. 2 is a schematic configuration diagram of an injection molding machine.

FIG. 3 is a diagram schematically describing the state determination device according to a first embodiment.

FIG. 4 is a diagram showing a molding cycle in which one molded article is manufactured.

FIG. 5 is a diagram showing examples of statistical conditions.

FIG. 6 is a diagram schematically describing a state determination device according to a second embodiment.

FIG. 7 is a diagram showing an example in which an operating screen for specifying statistical conditions is displayed on a display device.

FIG. 8 is a diagram showing an example of an alert displayed when abnormality occurs.

### DETAILED DESCRIPTION OF EMBODIMENTS OF THE INVENTION

Hereinafter, embodiments of the present invention will be described with reference to the drawings.

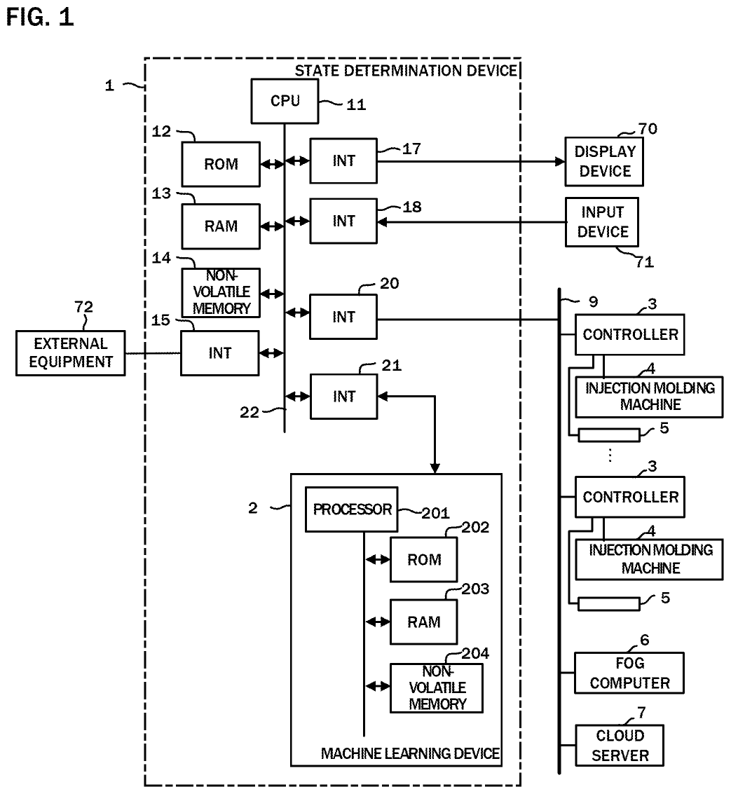

FIG. 1 is a schematic hardware configuration diagram showing the essential parts of a state determination device according to an embodiment of the present invention. A state determination device 1 according to the present embodiment can be mounted as, for example, a controller that controls an industrial machine on the basis of a control program. Further, the state determination device 1 according to the present embodiment can be mounted on a personal computer annexed to a controller that controls an industrial machine on the basis of a control program, a personal computer connected to a controller via a wired/wireless network, a cell computer, a fog computer 6, or a cloud server 7. The present embodiment shows an example in which the state determination device 1 is mounted on a personal computer connected to a controller 3 via a network 9. Note that as an industrial machine of which the state is to be determined by the state determination device of the present invention, an injection molding machine, a working machine, a mining machine, a wood working machine, an agricultural machine, a construction machine, or the like is illustrated. Hereinafter, an injection molding machine will be described as an example of an industrial machine.

A CPU 11 provided in the state determination device 1 according to the present embodiment is a processor that entirely controls the state determination device 1. The CPU 11 reads a system/program stored in a ROM 12 via a bus 22 and controls the entire state determination device 1 according to the system/program. In a RAM 13, temporary calculation data or display data and various data or the like input from an outside are temporarily stored.

A non-volatile memory 14 is constituted by, for example, a memory, an SSD (Solid State Drive), or the like backed up by a battery not shown, and its storage state is maintained even when the power supply of the state determination device 1 is turned off. In the non-volatile memory 14, data read from external equipment 72 via an interface 15, data input via an input device 71, data acquired from an injection molding machine 4 via the network 9, or the like is stored. The stored data may include, for example, data relating to physical amounts detected by various sensors 5 attached to the injection molding machine 4 controlled by the controller 3 such as the current, voltage, torque, position, speed, and acceleration of the motor of a driving unit, the pressure inside a mold, the temperature of an injection cylinder, and the flow volume or the flow rate of a resin, vibration, or sound. The data stored in the non-volatile memory 14 may be developed into the RAM 13 when executed/used. Further, various systems/programs such as known analysis programs are written in advance in the ROM 12.

The interface 15 is an interface used to connect the CPU 11 of the state determination device 1 and the external equipment 72 such as an external storage device to each other. From the side of the external equipment 72, a system/program or a program, a parameter, or the like relating to the operation of the injection molding machine 4 can be, for example, read. Further, data or the like generated/edited on the side of the state determination device 1 can be stored in an external storage medium such as a CF card and a USB flash drive not shown via the external equipment 72.

An interface 20 is an interface used to connect the CPU 11 of the state determination device 1 and the network 9 in a wired or wireless form to each other. The network 9 may be, for example, one that performs communication using a technology such as serial communication such as RS-485, Ethernet™ communication, optical communication, wireless LAN, Wi-Fi™, and Bluetooth™. The controller 3 that controls the injection molding machine 4, the fog computer 6, the cloud server 7, and the like are connected to the network 9, and these devices exchange data with the state determination device 1.

On a display device 70, respective data read onto a memory, data obtained as a result of the running of a program, data output from a machine learning device 2 that will be described later, or the like is output and displayed via an interface 17. Further, the input device 71 constituted by a keyboard, a pointing device, or the like transfers instructions, data, or the like based on an operator's manipulation to the CPU 11 via an interface 18.

An interface 21 is an interface used to connect the CPU 11 and the machine learning device 2 to each other. The machine learning device 2 includes a processor 201 that controls the entire machine learning device 2, a ROM 202 that stores a system/program or the like, a RAM 203 that is used to perform temporary storage in respective processing relating to machine learning, and a non-volatile memory 204 that is used to store a learning model or the like. The machine learning device 2 can observe, for example, data (data relating to physical amounts detected by the various sensors 5 attached to the injection molding machine 4 such as the current, voltage, torque, position, speed, and acceleration of the motor of the driving unit, the pressure inside a mold, the temperature of an injection cylinder, and the flow volume or the flow rate of a resin, vibration, or sound) acquirable by the state determination device 1 via the interface 21. Further, the state determination device 1 acquires a processing result output from the machine learning device 2 via the interface 21, and stores, displays, and transmits an acquired result to other devices via the network 9 or the like.

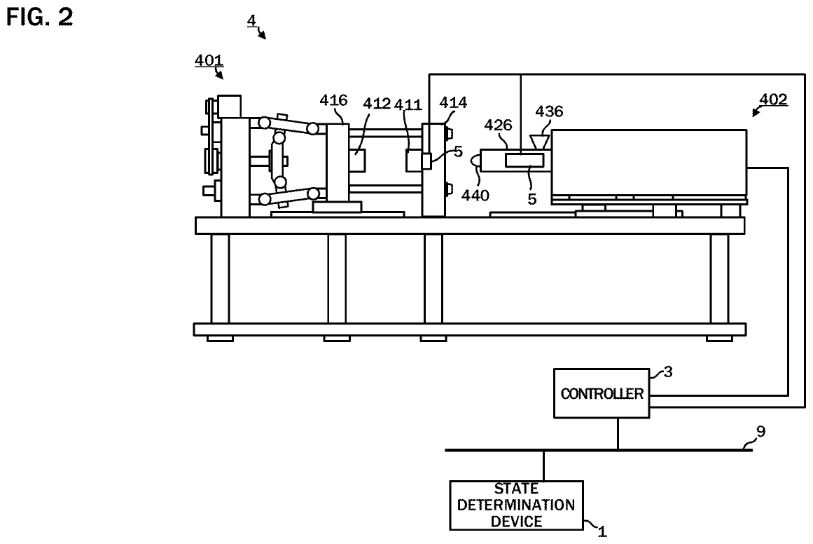

FIG. 2 is a schematic configuration diagram of the injection molding machine 4. The injection molding machine 4 is mainly constituted by a mold clamping unit 401 and an injection unit 402. In the mold clamping unit 401, a movable platen 416 and a fixed platen 414 are provided. Further, a movable-side mold 412 and a fixed-side mold 411 are attached to the movable platen 416 and the fixed platen 414, respectively. Meanwhile, the injection unit 402 is constituted by an injection cylinder 426, a hopper 436 that stores a resin material to be supplied to the injection cylinder 426, and a nozzle 440 that is provided at the tip end of the injection cylinder 426. In a molding cycle in which one molded article is manufactured, mold closing/mold clamping is performed by the movement of the movable platen 416 in the mold clamping unit 401, and a resin is injected into a mold via the nozzle 440 after the nozzle 440 is pressed to the fixed-side mold 411 in the injection unit 402. These operations are controlled according to instructions from the controller 3.

Further, the sensors 5 that detect physical amounts are attached to the respective portions of the injection molding machine 4, and physical amounts such as the current, voltage, torque, position, speed, and acceleration of the motor of the driving unit, the pressure inside a mold, the temperature of the injection cylinder 426, and the flow volume or the flow rate of a resin, vibration, or sound are detected by the sensors 5. The physical amounts detected by the sensors 5 are transmitted to the controller 3. In the controller 3, the detected respective physical amounts are stored in a RAM, a non-volatile memory, or the like not shown and transmitted to the state determination device 1 via the network 9 where necessary.

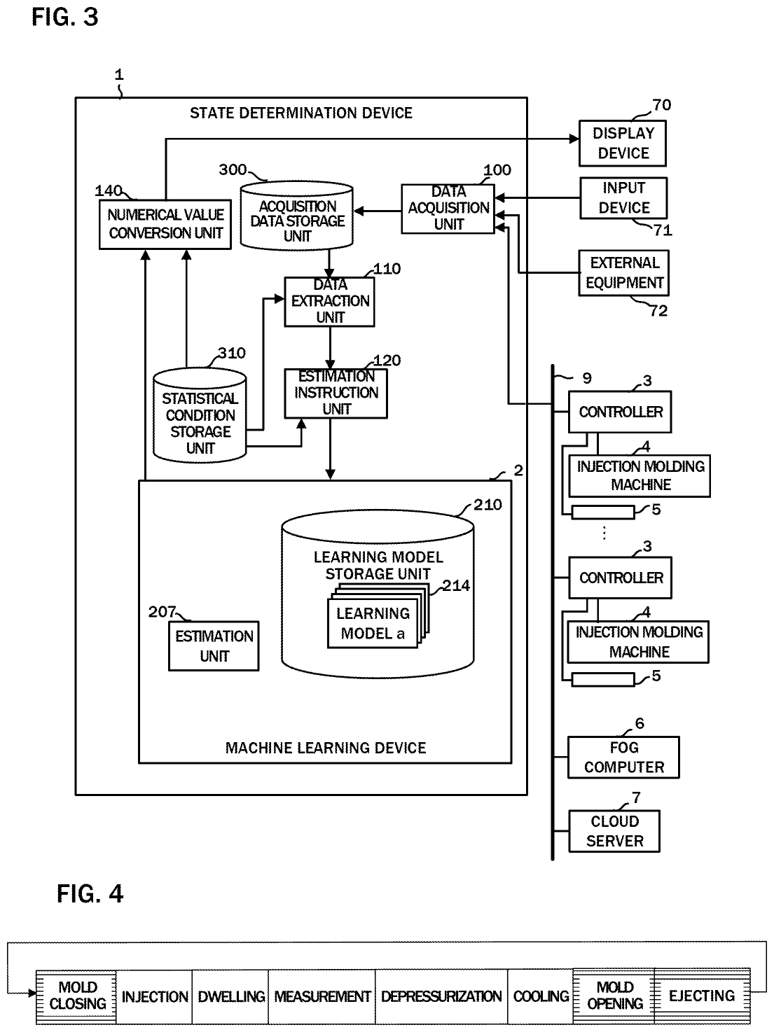

FIG. 3 shows a schematic block diagram of functions provided in the state determination device 1 according to a first embodiment of the present invention. The respective functions provided in the state determination device 1 according to the present embodiment are realized when each of the CPU 11 provided in the state determination device 1 and the processor 201 provided in the machine learning device 2 shown in FIG. 1 performs a system/program and controls the operations of the respective units of the state determination device 1 and the machine learning device 2.

The state determination device 1 according to the present embodiment includes a data acquisition unit 100, a data extraction unit 110, an estimation instruction unit 120, and a numerical value conversion unit 140. Further, the machine learning device 2 includes an estimation unit 207. Further, in the RAM 13 or the non-volatile memory 14 of the state determination device 1, an acquisition data storage unit 300 that serves as a region for storing data acquired from the controller 3 or the like by the data acquisition unit 100 and a statistical condition storage unit 310 that stores statistical conditions used for numerical value conversion by the numerical value conversion unit 140 are provided in advance. Further, on the RAM 203 or the non-volatile memory 204 of the machine learning device 2, a learning model storage unit 210 is provided in advance as a region for storing a plurality of learning models 214 having learned the correlation between data relating to prescribed physical amounts acquired from an industrial machine generated by a learning unit that will be described later and a state relating to the industrial machine.

The data acquisition unit 100 is realized when computation processing using the RAM 13 and the non-volatile memory 14 by the CPU 11 and input control processing by the interface 15, 18, or 20 are mainly performed as a result of the running of a system/program read from the ROM 12 by the CPU 11 provided in the state determination device 1 shown in FIG. 1. The data acquisition unit 100 acquires data relating to physical amounts detected by the sensors attached to the injection molding machine 4 such as the current, voltage, torque, position, speed, and acceleration of the motor of the driving unit, the pressure inside a mold, the temperature of the injection cylinder 426, and the flow volume or the flow rate of a resin, vibration, or sound. The data relating to the physical amounts acquired by the data acquisition unit 100 may be so-called time-series data that shows the values of physical amounts for each prescribed cycle. Further, the data acquisition unit 100 may directly acquire data from the controller 3 that controls the injection molding machine 4 via the network 9. The data acquisition unit 100 may acquire data acquired by and stored in the external equipment 72, the fog computer 6, the cloud server 7, or the like. The data acquisition unit 100 may acquire data relating to physical amounts for each process constituting one molding cycle by the injection molding machine 4. FIG. 4 is a diagram illustrating a molding cycle in which one molded article is manufactured. In FIG. 4, a mold closing process, a mold opening process, and an ejecting process that are the processes of shaded frames are performed in the operation of the mold clamping unit 401, and an injection process, a dwell process, a measurement process, a depressurization process, and a cooling process that are the processes of void frames are performed in the operation of the injection unit 402. The data acquisition unit 100 acquires the data relating to the physical amounts so as to be distinguishable for each of these processes. The data relating to the physical amounts acquired by the data acquisition unit 100 is stored in the acquisition data storage unit 300.

The data extraction unit 110 is realized when computation processing using the RAM 13 and the non-volatile memory 14 is mainly performed by the CPU 11 as a result of the running of a system/program read from the ROM 12 by the CPU 11 provided in the state determination device 1 shown in FIG. 1. The data extraction unit 110 extracts data for processing relating to the machine learning of estimation processing or the like by the machine learning device 2 among data relating to physical amounts acquired by the data acquisition unit 100 from the acquisition data storage unit 300. The extraction of the data by the data extraction unit 110 is performed on the basis of statistical conditions stored in the statistical condition storage unit 310.

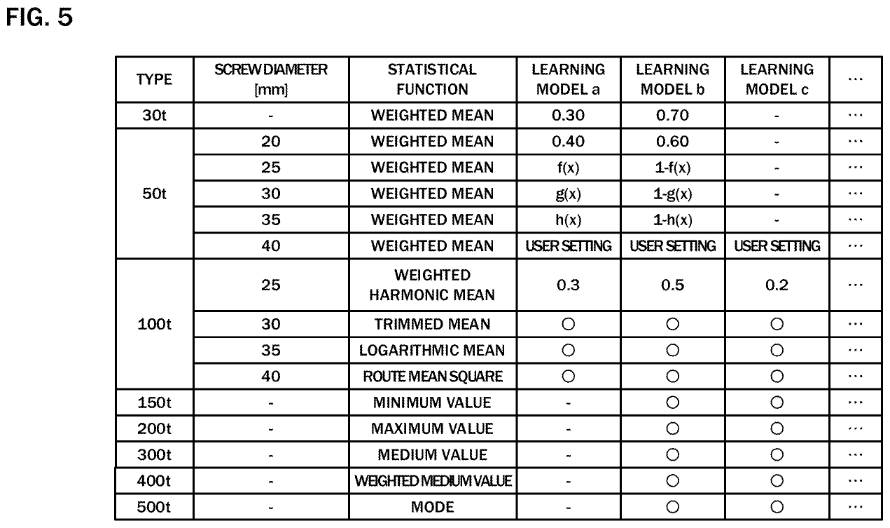

The statistical conditions define a way to calculate the estimation result of the current state of an industrial machine. The statistical conditions include at least the specification of a plurality of learning models used to determine a state relating to an industrial machine and a statistical function used to convert estimation results by the specified learning models into numerical values to calculate a statistical amount. The statistical conditions may be generated for each type (machine size or the like) of an industrial machine or for each type of equipment attached to the industrial machine. As the statistical function included in the statistical conditions, a prescribed statistical function such as a weighted mean, an arithmetic mean, a weighted harmonic mean, a harmonic mean, a trimmed mean, a logarithmic mean, a route mean square, a minimum value, a maximum value, a medium value, a weighted medium value, and a mode considering the relationship between a determined state and respective learning models may be, for example, set. For example, a weighted mean in which a weight is changed according to the correlation between the type of an industrial machine and the estimation results of respective learning models may be used. Further, when it is determined that an industrial machine is in an abnormal state in a case in which even one of the estimation results of a plurality of learning models shows a prescribed state (for example, an abnormal state), a maximum value (or a minimum value) among the estimation results of the plurality of learning models may be selected and used. Further, when a determination is made except for an outlier in a case in which the outlier largely deviated from an average of estimation results is included in the estimation results of a plurality of learning models, the medium value or the mode of the estimation results of the plurality of learning models may be used. FIG. 5 is a diagram illustrating statistical conditions in which the types and the screw diameters of an injection molding machine and statistical functions are associated with each other. In the example of FIG. 5, when the type of an injection molding machine (where a screw diameter is arbitrary) has a clamping force of 30 t, a weighted mean is calculated assuming that a weight for an estimation result by a learning model a is 0.30 and a weight for an estimation result by a learning model b is 0.70 using the estimation results of the learning model a and the learning model b, and the calculated weighted mean is defined as an estimation value for determining the state of the injection molding machine. Further, when an injection molding machine has a clamping force of 100 t and has a screw diameter of 30 mm, a trimmed mean of estimation results is calculated using the estimation results by the learning models a and b and a learning model c, and the calculated trimmed mean is defined as an estimation value for determining the state of the injection molding machine. A parameter such as a weight relating to an estimation result by a learning model used in the computation of a statistical function may be defined by a fixed value such as a weight as described above. Further, a parameter such as a weight may be calculated using a function such as a trigonometric function, a hyperbolic function, and a sigmoid function in which a prescribed value (hyper parameter) determined in advance by an experiment or the like is used as an argument. For example, when an injection molding machine has a clamping force of 50 t and has a screw diameter of 25 mm, tanh(x) that is a kind of a hyperbolic function in which a hyper parameter x is used as an argument to calculate a weighted mean of estimation results is used as a function f(x) to calculate the weight of the weighted mean using the estimation results by the learning models a and b. In this case, a weighted mean is calculated assuming that a weight for an estimation result by the learning model a is a value calculated by the function f(x) and the value of a weight for an estimation result by the learning model b is 1−f(x), and the calculated weighted mean is used as an estimation value for determining the state of the injection molding machine. Note that functions f(x), g(x), and h(x) used to calculate weights relating to the learning models in the example of FIG. 5 may include, besides the function tanh(x) described above, a trigonometric function such as sin (x) and cos (x) in which a hyper parameter x is used as an argument and a sigmoid function. For example, the hyper parameter x that is an argument of a function at this time may be manually set by an operator on an operating screen or may be determined in advance by an experiment. Thus, there is an advantage that a parameter such as a weight is easily adjusted in an analog way. Further, a parameter such as a weight may be directly set from a user setting screen.

By referring to the statistical condition storage unit 310 in which such statistical conditions are stored, the data extraction unit 110 specifies a plurality of learning models necessary for determining a state relating to an industrial machine. Then, the data extraction unit 110 extracts data necessary for performing estimation processing in the plurality of specified learning models from the acquisition data storage unit 300 in which data acquired by the data acquisition unit 100 is stored.

Note that the example of FIG. 5 shows statistical conditions for each type and each screw diameter of an injection molding machine. However, for example, different statistical conditions may be set when an operating situation is different as in the cases of an energy-saving operation, a safety-oriented operation, a productivity-oriented operation, or the like, different statistical conditions may be set assuming that a prescribed period (for example, a first 100 molding cycle) after the start of producing a prescribed product and a period after the prescribed period are different situations, or statistical conditions may be set for each season (such as summer and winter). That is, statistical conditions may be created for each situation of an environment to be determined. Further, a situation in which these conditions are combined together may be defined as the operating conditions of an industrial machine, and respective statistical conditions may be created for the operating conditions. This is because an estimation value by a learning model fluctuates since production is unstable and therefore the occurrence rate of defectives is high immediately after the start of the production, while abnormality such as a temporary stop hardly occurs and an operating state is stably reflected in an estimation value in a state in which the production is stabilized. Therefore, in the former case, by making the weight of a learning model placing emphasis on the accuracy of a product small and the weight of a learning model (dull to an abnormal situation) hardly susceptible to the fluctuation of learning data large, a false determination due to the fluctuation of an estimation value by a learning model is reduced. In the latter case, by making the weight of a learning model placing emphasis on the accuracy of a product or the weight of a learning model placing emphasis on production efficiency large, abnormality can be found at an early stage since a statistical amount (abnormal degree) promptly and largely fluctuates even when the slight abnormality occurs. Further, the operation of an industrial machine is susceptible to temperature or humidity. Therefore, by conducting an experiment for each season, examining the correlation between a state to be determined and an estimation value of a learning model, and setting a weight for the estimation value of the learning model according to the result, determination accuracy can be improved.

As described above, statistical conditions are defined so that the estimation results of a plurality of learning models corresponding to a difference in an injection molding machine such as the type and the screw diameter of the injection molding machine are used, whereby it is possible to determine the abnormality state of an injection molding machine different from an injection molding machine used to generate a learning model.

Further, statistical conditions are defined so that the estimation results of a plurality of learning models corresponding to a difference in an operating situation or an environment situation or the estimation results of a plurality of learning models corresponding to the accuracy of a product or a difference in production efficiency are used, whereby it is possible to perform a comprehensive determination or a general determination responding to various production environments or operator's demands.

Further, the statistical conditions may be expressed in a table form as illustrated in FIG. 5 but may expressed in other forms such as a mathematical formula. In both cases, the statistical conditions may be defined in such a manner that a plurality of used learning models and a statistical function applied to estimation results by the learning models are associated with each other. Thus, it is possible to comprehensively determine a state relating to an industrial machine on the basis of a statistical amount calculated by applying a statistical function to the estimation results of a plurality of learning models.

The estimation instruction unit 120 is realized when computation processing using the RAM 13 and the non-volatile memory 14 and input/output processing using the interface 21 are mainly performed by the CPU 11 as a result of the running of a system/program read from the ROM 12 by the CPU 11 provided in the state determination device 1 shown in FIG. 1. The estimation instruction unit 120 specifies, by referring to the statistical condition storage unit 310, learning models that are to be subjected to estimation processing. Then, the estimation instruction unit 120 instructs the machine learning device 2 to perform estimation processing using the respective specified learning models.

The numerical value conversion unit 140 is realized when computation processing using the RAM 13 and the non-volatile memory 14 and input/output processing using the interface 21 are mainly performed by the CPU 11 as a result of the running of a system/program read from the ROM 12 by the CPU 11 provided in the state determination device 1 shown in FIG. 1. The numerical value conversion unit 140 performs, by referring to the statistical condition storage unit 310, the computation of a statistical function using values as estimation results by a plurality of learning models acquired from the machine learning device 2. Then, the numerical value conversion unit 140 outputs the computation result as an estimation value for determining a state relating to an industrial machine. The estimation value output from the numerical value conversion unit 140 may be displayed on and output to the display device 70. At this time, the estimation value may be displayed and output as it is. Alternatively, a state determination in which the estimation value is compared with a previously-set threshold or a state classification determination may be performed, and the determination result may be output. Further, the estimation value may be transmitted and output to the controller 3 of the injection molding machine 4 of which the operating state is to be determined, or may be transmitted and output to a higher-level device such as the fog computer 6 and the cloud server 7 via the network 9.

On the other hand, the estimation unit 207 provided in the machine learning device 2 is realized when computation processing using the RAM 203 and the non-volatile memory 204 is mainly performed by the processor 201 as a result of the running of a system/program read from the ROM 202 by the processor 201 provided in the machine learning device 2 shown in FIG. 1. The estimation unit 207 selects a plurality of learning models 214 from the learning model storage unit 210 on the basis of instructions from the estimation instruction unit 120 and performs estimation processing using the respective learning models 214. Then, the estimation unit 207 outputs a plurality of estimation results to the numerical value conversion unit 140.

A plurality of learning models 214 are stored in advance in the learning model storage unit 210. As the learning models 214, previously-generated learning models are stored. Each of the learning models 214 is one having been subjected to learning in a different situation and has various different characteristics. For example, a learning model used to determine the state of an injection molding machine may be a learning model that acquires data (an injection speed and a pressure inside a mold in the injection process, a screw rotating speed, a screw torque, a pressure inside a cylinder, or the like in the measurement process) relating to a different physical amount and uses the same as learning data for each molding-cycle process (such as the injection process, a dwell process, the measurement process, a depressurization process, and a cooling process), and is generated for each of the processes (depending on operating situations). A learning model used to determine the state of an injection molding machine may be a learning model that acquires data relating to a physical amount for each different configuration situation such as the type (such as a motor and a gear) of equipment constituting the injection molding machine, the type of a production material, and the type (such as a mold, a mold temperature conditioning machine, and a resin drying machine) of an accessory facility and use the same as learning data, and is generated for each configuration situation. A learning model used to determine the state of an injection molding machine may be a learning model that acquires data relating to a physical amount for each different production environment (the stability of power supply, a seasonal factor in summer or winter) and use the same as learning data, and may be generated for each environment situation. Due to these different situations, a suitable type and a suitable environment are different between the respective learning models.

A learning model used to determine a state relating to an industrial machine may be one generated for a different learning method such as supervised learning (such as multilayer perceptron, recurrent neural network, and convolutional neural network), unsupervised learning (such as auto encoder, k-means clustering, and generative adversarial network), and reinforcement learning (Q-learning). Further, a learning model may be one in which a constituting element (such as the type of a hyper parameter and the type of an optimization function during machine learning) in each algorithm is different. Due to these differences, a calculation load (calculation time) during learning processing and estimation processing, the accuracy of an estimation value, and robustness (stability) with respect to learning data are different between the respective learning models.

A learning model used to determine a state relating to an industrial machine may be stored in advance in a compressed state, and uncompressed to be used during computation. Thus, a memory can be efficiently used or an operation can be performed with a small memory amount, which produces the advantage of reducing a cost. Further, a learning model may be encrypted and stored. The storage of a learning model in an encrypted state is preferable in terms of security or information concealment.

An example of estimation processing using the state determination device 1 including the above configuration according to the present embodiment will be described. In this example, it is assumed that at least a learning model a and a learning model b are stored in advance in the learning model storage unit 210. The learning model a is one generated by performing supervised learning in which the time-series data of an injection speed and a pressure inside a mold acquired in an injection process from an injection molding machine having a clamping force of 30 t is used as learning data and data showing the normality or abnormality of an operation at that time is used as label data. The learning model b is one generated by performing supervised learning in which the time-series data of a screw rotation speed, a screw torque, and a pressure inside a cylinder acquired in a measurement process from an injection molding machine having a clamping force of 30 t is used as learning data and data showing the normality or abnormality of an operation at that time is used as label data. Further, it is assumed that the statistical conditions illustrated in FIG. 5 are stored in the statistical condition storage unit 310. In this case, an operating state in a case in which a screw having a screw diameter of 20 mm is attached to an injection molding machine having a clamping force of 50 t is determined.

The data extraction unit 110 extracts, by referring to statistical conditions matching the injection molding machine to be determined, the time-series data of an injection speed and a pressure inside a mold in an injection process and the time-series data of a screw rotation speed, a screw torque, and a pressure inside a cylinder in a measurement process as data for extraction.

Next, the estimation instruction unit 120 instructs, using the data extracted by the data extraction unit 110, the machine learning device 2 to perform the estimation processing of the operating state of the injection molding machine using each of the learning model a and the learning model b.

Upon receiving the instruction, the estimation unit 207 performs the estimation processing using the learning model a and the learning model b stored in the learning model storage unit 210 and outputs respective abnormal degrees to the numerical value conversion unit 140 as the estimation results.

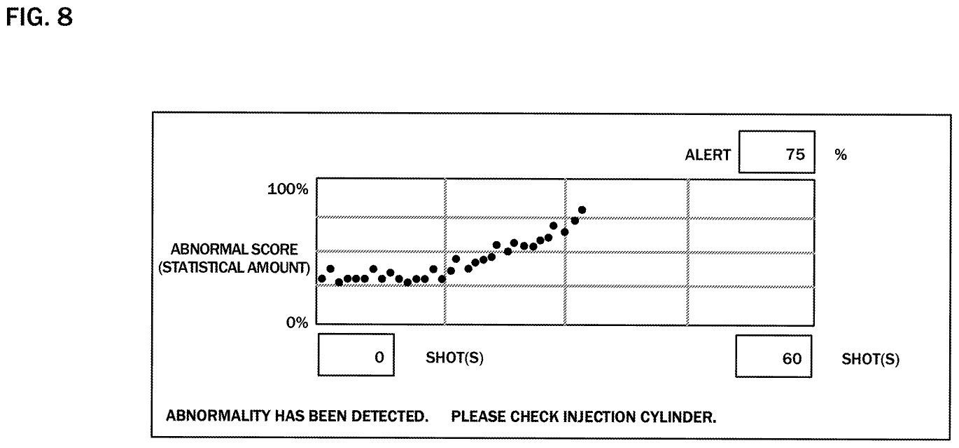

The numerical value conversion unit 140 refers to the statistical condition storage unit 310 and performs computation using a weighted mean function in which the estimation result of the learning model a is weighted by 0.4 and the estimation result of the learning model b is weighted by 0.6 as a statistical function where the injection molding machine having a clamping force of 50 t has a screw diameter of 20 mm. For example, when the estimation result of an abnormal degree by the learning model a is 0.7 and the estimation result of the abnormal degree by the learning model b is 0.5, the numerical value conversion unit 140 outputs 0.4×0.7+0.6×0.5=0.58 as a statistical amount for determining the state of the injection molding machine having a clamping force of 50 t to which a screw having a screw diameter of 20 mm is attached. Since the statistical amount thus output reflects the respective estimation results of the learning model a and the learning model b, it is possible to determine the comprehensive abnormal degree of the injection molding machine with the statistical amount. Further, when the statistical amount exceeds a threshold Thₑ of an abnormal degree set in advance, the numerical value conversion unit 140 outputs an alert determining that abnormality has occurred in the operation of the injection molding machine. FIG. 8 shows a display example of a screen in which a statistical amount is plotted as an abnormal score on the screen displayed on the display device 70 and an alert message “Abnormality has been detected. Please check an injection cylinder.” is output as an alert. Then, the operation of an injection molding machine may be stopped or decelerated, or the driving torque of a motor that drives the driving unit of the injection molding machine may be suppressed.

Next, an example of another estimation processing using the state determination device 1 according to the present embodiment will be described. In this example, it is assumed that at least a learning model a and a learning model b are stored in advance in the learning model storage unit 210. The learning model a is one generated by performing supervised learning in which the time-series data of an injection speed and a pressure inside a mold acquired in an injection process from an injection molding machine having a clamping force of 30 t is used as learning data and vector values ((1, 0, 0, 0, 0) when a sink failure occurs but other failures do not occur) corresponding to the type (sink: a failure in which a molded article is depressed, warpage: deformation of a molded article due to residual stress, burning: discoloration of a molded article, void: a hole, crack: breaking or cracking of a molded article) of a molding failure are used as label data if a product molded at that time has the molding failure. The learning model b is one generated by performing supervised learning in which the time-series data of a screw rotation speed, a screw torque, and a pressure inside a cylinder acquired in a measurement process from an injection molding machine weighing 30 t is used as learning data and vector values corresponding to the type (sink: a failure in which a molded article is depressed, warpage: deformation of a molded article due to residual stress, burning: discoloration of a molded article, void: a hole, crack: breaking or cracking of a molded article) of a molding failure are used as label data if a product molded at that time has a molding failure. Further, it is assumed that the statistical conditions illustrated in FIG. 5 are stored in advance in the statistical condition storage unit 310. In this case, the failure state of a molded article in a case in which a screw having a screw diameter of 20 mm is attached to an injection molding machine having a clamping force of 50 t is determined.

The data extraction unit 110 extracts, by referring to statistical conditions matching the injection molding machine to be determined, the time-series data of an injection speed and a pressure inside a mold in an injection process and the time-series data of a screw rotation speed, a screw torque, and a pressure inside a cylinder in a measurement process as data for extraction.

Next, the estimation instruction unit instructs, using the data extracted by the data extraction unit 110, the machine learning device 2 to perform the estimation processing of the failure state of the molded article using each of the learning model a and the learning model b.

Upon receiving the instruction, the estimation unit 207 performs the estimation processing using the learning model a and the learning model b stored in the learning model storage unit 210 and outputs vector values showing respective failure states to the numerical value conversion unit 140 as the estimation results. The numerical value conversion unit 140 refers to the statistical condition storage unit 310 and performs computation using a weighted mean function in which the estimation result of the learning model a is weighted by 0.4 and the estimation result of the learning model b is weighted by 0.6 as a statistical function where the injection molding machine having a clamping force of 50 t and a screw diameter of 20 mm. For example, when the estimation result of vector values showing the failure state of the molded article by the learning model a is yₐ=(0.10, 0.20, 0.20, 0.30, 0.20) and the estimation result of vector values showing the failure state of the molded article by the learning model b is y_{b}=(0.20, 0.10, 0.30, 0.20, 0.20), the numerical value conversion unit 140 outputs 0.4×yₐ+0.6×y_{b}=(0.16, 0.14, 0.26, 0.24, 0.20) as a statistical amount for determining the failure state of the molded article. Here, the largest value 0.26 among the vector values showing the failure state of the molded article output from the numerical value conversion unit 140 is in the third place among the vectors, “burning: discoloration of a molded article” is determined as the failure state of the molded article (sink: a failure in which a molded article is depressed, warpage: deformation of a molded article due to residual stress, burning: discoloration of a molded article, void: a hole, crack: breaking or cracking of a molded article). Further, when there is a type of a molding failure having a statistical amount exceeding a threshold Th_{b} of the failure state of a molded article set in advance, the numerical value conversion unit 140 may output an alert determining that the molding failure has occurred.

The state determination device 1 including the above configuration according to the present embodiment is allowed to comprehensively determine a state relating to an industrial machine when a statistically-processed statistical amount is calculated on the basis of estimation values obtained by a plurality of learning models. Further, learning models may not be provided for operating conditions or the like such as all types, configurations, operating situations, periods since the start of production, environment situations. In this case, learning models are provided in advance for some typical types, configurations, or the like, and the relationships between the learning models and the other types, configurations, operating conditions, or the like are confirmed by an experiment or the like to generate statistical conditions in advance, whereby it is possible to perform estimation processing with a certain degree of accuracy without collecting huge learning data. Thus, it is possible to reduce a cost for the operation of a machine learning device.

Further, in order to ensure the safety of an operator, it is possible to display an alert showing an abnormal state on a display device on the basis of a statistical amount calculated by statistically processing abnormal degrees obtained as a plurality of machine learning outputs, stop the operation of an industrial machine when a statistical amount exceeds a prescribed threshold, or decelerate a motor that drives a movable unit or suppress the driving torque of the motor so that the movable unit operates in a safe state.

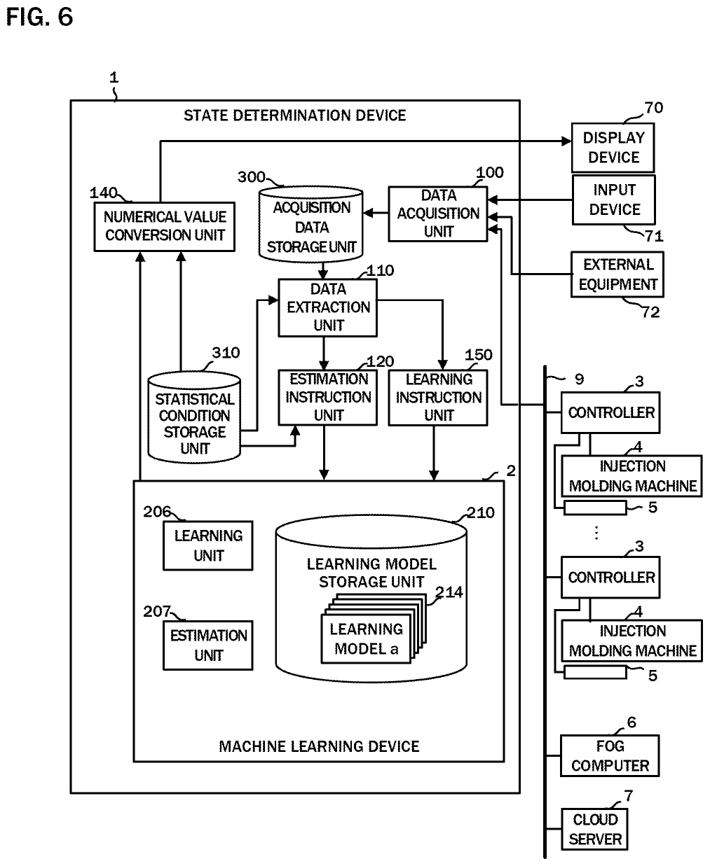

FIG. 6 shows a schematic block diagram of functions provided in a state determination device 1 according to a second embodiment of the present invention. The respective functions provided in the state determination device 1 according to the present embodiment are realized when a CPU 11 provided in the state determination device 1 and a processor 201 provided in a machine learning device 2 shown in FIG. 1 perform a system/program and control the operations of the respective units of the state determination device 1 and the machine learning device 2.

The state determination device 1 according to the present embodiment also includes a learning instruction unit 150 in addition to the respective functions provided in the state determination device 1 according to the first embodiment. Further, the machine learning device 2 also includes a learning unit 206.

A data extraction unit 110 according to the present embodiment functions like the data extraction unit 110 according to the first embodiment when performing estimation processing. Meanwhile, the data extraction unit 110 extracts, when receiving instructions from an operator or the like to advance learning with the machine learning device 2, data for processing relating to machine learning such as learning processing from an acquisition data storage unit 300. The data extraction unit 110 extracts data for the learning processing of one or more specified learning models from the acquisition data storage unit 300 storing data acquired by the data acquisition unit 100.

The learning instruction unit 150 is realized when computation processing using a RAM 13 and a non-volatile memory 14 and input/output processing using an interface 21 are mainly performed by the CPU 11 as a result of the running of a system/program read from a ROM 12 by the CPU 11 provided in the state determination device 1 shown in FIG. 1. The learning instruction unit 150 instructs the machine learning device 2 to perform learning processing using data extracted by the data extraction unit 110 for each of one or more specified learning models.

Meanwhile, the learning unit 206 provided in the machine learning device 2 is realized when computation processing using a RAM 203 and a non-volatile memory 204 is mainly performed by the processor 201 as a result of the running of a system/program read from a ROM 202 by a processor 201 provided in the machine learning device 2 shown in FIG. 1. The learning unit 206 selects one or more learning models 214 to be learned from a learning model storage unit 210 on the basis of instructions from the learning instruction unit 150 and performs learning processing using the respective learning models 214. The learning unit 206 may newly generate learning models when learning models instructed by the learning instruction unit 150 are not stored in the learning model storage unit 210.

The state determination device 1 including the above configuration according to the present embodiment is allowed to advance the learning processing of one or more learning models 214 on the basis of instructions from an operator. By the update of a learning model in a case in which useful data can be acquired to advance learning or the like, a further improvement in the estimation accuracy of estimation processing can be expected.

An embodiment of the present invention is described above. The present invention is not limited to the example of the embodiment described above but can be carried out in various modes with the addition of appropriate modifications.

The above embodiments describe an injection molding machine as an example, but machines of which the state is to be determined may be other industrial machines. For example, in a working machine, the abnormality of a main shaft may be determined by a plurality of learning models corresponding to a cutting tool assembled to the main shaft, the type or flow rate of a processing liquid used to cool the cutting tool, a workpiece material, or the like. In a wood working machine, the abnormality of a rotating tool may be determined by a plurality of learning models corresponding to the type, rotation speed, or the like of the rotating tool. In an agricultural machine, the abnormality of a driving unit may be determined by a plurality of learning models corresponding to a driving force applied to the driving unit, equipment provided in the driving unit, or the like. In a construction machine or a mining machine, the abnormality of a hydraulic cylinder may be determined by a plurality of learning models corresponding to the type of a hydraulic hose connected to the hydraulic cylinder, the output of a motor, an operation environment, or the like.

Further, the above embodiments describe a case in which the machine learning device 2 is included in the state determination device 1, but the machine learning device 2 may be installed on the outside of the state determination device 1 so as to be able to exchange data with the state determination device 1. For example, the machine learning device 2 may be configured to be arranged on the fog computer 6 or the cloud server 7 and perform the transmission of instructions or the reception of estimation results via the network 9. With this configuration, it is possible share the machine learning device 2 between a plurality of the state determination devices 1 and reduce an installation cost.

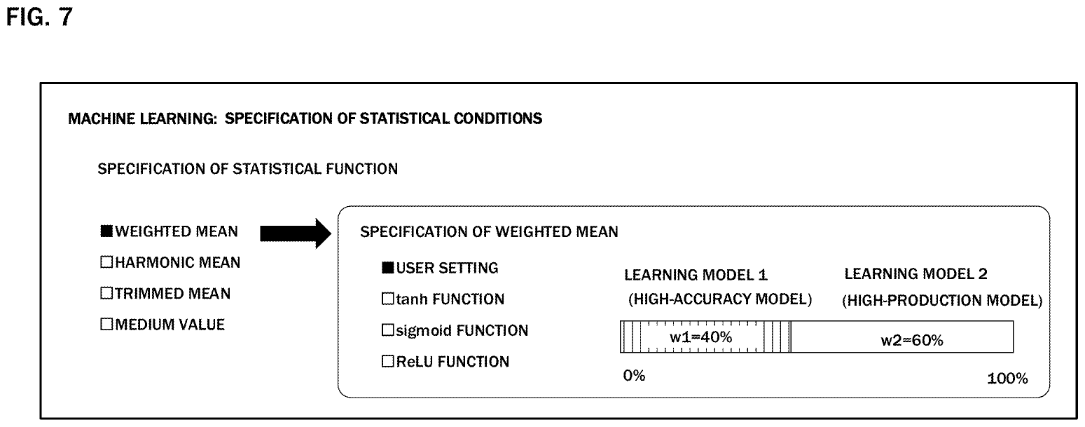

Moreover, statistical conditions may be set on the basis of an operator's setting as illustrated in FIG. 7. In the example of FIG. 7, an operator specifies a weighted mean as a statistical function, and specifies a weight for an estimation result by a learning model 1 (high-accuracy model) as 0.4 (40%) and a weight for an estimation result by a learning model 2 (high-production model) as 0.6 (60%) as weights of the weighted mean. Thus, a weighted mean is calculated using the specified weights, and the calculated weighted mean is used as an estimation value used to determine the state of the injection molding machine. On this occasion, the type of the statistical function and the setting of the parameter of the statistical function may also be specified on a user setting screen. In this manner, it is possible for the operator using an industrial machine to set appropriate statistical conditions in accordance with a factory environment or the like.

### REFERENCE SIGNS LIST

1 State determination device
2 Machine learning device
3 Controller
4 Injection molding machine
5 Sensor
6 Fog computer
7 Cloud server
9 Network
11 CPU
12 ROM
13 RAM
14 Non-volatile memory
17, 18, 20, 21 Interface
22 Bus
70 Display device
71 Input device
72 External equipment
100 Data acquisition unit
110 Data extraction unit
120 Estimation instruction unit
140 Numerical value conversion unit
150 Learning instruction unit
201 Processor
202 ROM
203 RAM
204 Non-volatile memory
206 Learning unit
207 Estimation unit
210 Learning model storage unit
214 Learning models
300 Acquisition data storage unit
310 Statistical condition storage unit

1. A state determination device that determines a state relating to an industrial machine, the state determination device comprising:
a learning model storage unit that stores a plurality of learning models having learned correlation between data relating to a prescribed physical amount acquired from the industrial machine and a state relating to the industrial machine;
a statistical condition storage unit that stores statistical conditions including at least specification of the plurality of learning models used to determine the state relating to the industrial machine and a statistical function used to convert estimation results by the specified learning models into numerical values to calculate a statistical amount;
a data acquisition unit that acquires data relating to a prescribed physical amount as data showing the state relating to the industrial machine;
an estimation unit that estimates the state relating to the industrial machine using the plurality of learning models stored in the learning model storage unit on a basis of the data acquired by the data acquisition unit; and
a numerical value conversion unit that refers to the statistical condition storage unit to acquire the statistical function and converts an estimation result for each of the plurality of learning models by the estimation unit into a numerical value to calculate a statistical amount using the acquired statistical function.

2. The state determination device according to claim 1, wherein
the statistical conditions are generated in association with at least one of a type of the industrial machine of which a state is to be determined and equipment attached to the industrial machine, and
the numerical value conversion unit acquires a statistical function to be used on a basis of at least one of the type of the industrial machine of which the state is to be determined and the equipment attached to the industrial machine.

3. The state determination device according to claim 2, wherein
the statistical conditions are generated in association with operating conditions of the industrial machine, and
the numerical value conversion unit acquires a statistical function to be used on a basis of the operating conditions.

4. The state determination device according to claim 1, wherein
the statistical function is any one of a weighted mean, an arithmetic mean, a weighted harmonic mean, a harmonic mean, a trimmed mean, a logarithmic mean, a route mean square, a minimum value, a maximum value, a medium value, a weighted medium value, and a mode.

5. The state determination device according to claim 1, wherein
a parameter of the statistical function is a prescribed fixed value or a numerical value calculated using a prescribed function.

6. The state determination device according to claim 1, further comprising:
a learning unit that performs machine learning using the data acquired by the data acquisition unit to generate or update a learning model.

7. The state determination device according to claim 1, wherein
an interface allowing an operator to edit an element of statistical conditions stored in the statistical condition storage unit is provided.

8. The state determination device according to claim 1, wherein
the estimation unit estimates an abnormal degree relating to an operating state of the industrial machine, and
an alert message is displayed when a statistical amount exceeds a prescribed threshold, the statistical amount being calculated in such a manner that the numerical value conversion unit converts an estimation result for each of a plurality of learning models by the estimation unit into a numerical value using the statistical function.

9. The state determination device according to claim 1, wherein
the estimation unit estimates an abnormal degree relating to an operating state of the industrial machine, and
an operation of the industrial machine is stopped or decelerated or a driving torque of a motor that drives the industrial machine is suppressed when a statistical amount exceeds a prescribed threshold, the statistical amount being calculated in such a manner that the numerical value conversion unit converts an estimation result for each of a plurality of learning models by the estimation unit into a numerical value using the statistical function.

10. The state determination device according to claim 1, wherein
the data acquired by the data acquisition unit is at least one of data items acquired from a plurality of industrial machines connected via a wired or wireless network.

11. A state determination method for determining a state relating to an industrial machine in which
a plurality of learning models having learned correlation between data relating to a prescribed physical amount acquired from the industrial machine and a state relating to the industrial machine are stored in advance, and
statistical conditions including at least specification of the plurality of learning models used to determine the state relating to the industrial machine and a statistical function used to convert estimation results by the specified learning models into numerical values to calculate a statistical amount are stored in advance,
the state determination method comprising:
a step of acquiring data relating to a prescribed physical amount as data showing the state relating to the industrial machine;
a step of estimating the state relating to the industrial machine using the plurality of learning models stored in advance on a basis of the data acquired in the acquisition step; and
a step of acquiring the statistical function included in the statistical conditions stored in advance and converting an estimation result for each of the plurality of learning models in the estimation step into a numerical value to calculate a statistical amount using the acquired statistical function.
